(19) United States
(12) Patent Application Publication
(10) Pub. No.: US 2015/0360397 A1
(43) Pub. Date: Dec. 17, 2015

(54) LONG FIBER THERMOPLASTIC HELMET INSERTS AND HELMETS AND METHODS OF MAKING EACH

(71) Applicant: THE UAB RESEARCH FOUNDATION, Birmingham, AL (US)

(72) Inventor: Uday Vaidya, Birmingham, AL (US)

(21) Appl. No.: 14/677,216

(22) Filed: Apr. 2, 2015

Related U.S. Application Data
(63) Continuation of application No. 13/266,179, filed on Oct. 25, 2011, now abandoned.
(60) Provisional application No. 61/178,175, filed on May 14, 2009.

(51) Int. Cl. B29C 43/00; B29B 9/06; B29C 43/02; B29B 15/14; A42B 3/00; C08K 7/06

(52) U.S. Cl. CPC B29C 43/003; A42B 3/00; C08K 7/06; B29C 43/027; B29C 43/021; B29B 15/14; B29B 9/06; B29L 2031/4821

(57) ABSTRACT

Embodiments of the present disclosure include helmet liners, helmets, helmets with deflective structures, helmets with thermochromic features, and methods of making helmet liners, helmets, helmets with deflective structures, and helmets with thermochromic features.

### CROSS-REFERENCE TO RELATED APPLICATION

This application is a continuation of U.S. application Ser. No. 13/266,179, entitled “LONG FIBER THERMOPLASTIC HELMET INSERTS AND HELMETS AND METHODS OF MAKING EACH”, which claims priority to PCT application serial number PCT/US10/34854, entitled LONG FIBER THERMOPLASTIC HELMET INSERTS AND HELMETS AND METHODS OF MAKING EACH, filed on May 14, 2010 which claims priority to U.S. provisional application Ser. No. 61/178,175, entitled “LONG FIBER THERMOPLASTIC HELMET INSERTS AND HELMETS AND METHODS OF MAKING EACH” filed on May 14, 2009, which all are entirely incorporated herein by reference.

### STATEMENT REGARDING FEDERALLY SPONSORED RESEARCH OR DEVELOPMENT

Aspects of this disclosure may have been made with government support undre W911NF-04-2-0018 awarded by the Army Research Laboratory, Aberdeen, Md. The government may have certain rights in the invention(s).

### BACKGROUND

In recent years, the Personnel Armor System Ground Troops (PASGT) helmets have been replaced with the Advanced Combat Helmet (ACH). There are several challenges in developing a new set of materials for use in future U.S. Army systems. The primary technical barrier is to deliver a safe, durable, robust helmet system at a lighter weight. Another concern is the ability to introduce new materials and processing technologies to the current manufacturing capabilities within the U.S. in terms of producibility and high volume production. Cost and high performance continue to be a major driver for thermoplastic technologies.

### SUMMARY

Embodiments of the present disclosure include helmet liners, helmets, helmets with deflective structures, helmets with thermochromic features, and methods of making helmet liners, helmets with deflective structures, and helmets with thermochromic features.

Briefly described, an embodiment of the present disclosure includes a long fiber thermoplastic structure, among others, including: a thermoplastic resin; and a plurality of discontinuous reinforcing fiber, wherein each of the discontinuous reinforcing fiber has a fiber length of about 3 mm to 50 mm.

Briefly described, an embodiment of the present disclosure includes a long fiber thermoplastic structure, among others, including: a thermoplastic resin; and a continuous reinforcing fiber, wherein the continuous reinforcing fiber is hot melt impregnated with the thermoplastic resin.

Briefly described, an embodiment of the present disclosure includes a method for making a long fiber thermoplastic structure, among others, including: hot melt impregnating a continuous reinforcing fiber with a thermoplastic matrix to form a continuous tow; cutting the continuous tow into a plurality of pellets, wherein the pellets include a discontinuous reinforcing fiber formed from the cutting of the continuous reinforcing fiber; feeding the plurality of pellets into a structure to form long fiber thermoplastic; extruding a plurality of molten charges; introducing a continuous reinforcing fiber to a compression molding press; transferring the molten charge to the compression molding press; and forming the molten charge into a structure, wherein the structure includes the continuous reinforcing fiber and the long fiber thermoplastic.

Briefly described, an embodiment of the present disclosure includes a helmet, among others, including: a continuous fiber material; and a polymer, wherein the polymer is chosen from: a thermoplastic polymer and a thermoset polymer.

### BRIEF DESCRIPTION OF THE DRAWINGS

Many aspects of this disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 illustrates an embodiment of a rim stiffened liner and shell system.

FIG. 2A illustrates an embodiment of a flat face deflective shell helmet.

FIG. 2B illustrates an embodiment of a prism shape deflective shell helmet.

FIG. 2C illustrates a deflective cap inserted over ACH or any other helmet shell.

FIGS. 3A-3B illustrate modeling and simulation of regular (present generation) versus deflective shape helmets.

FIG. 4 illustrates thermochromic behavior in a LFT composite.

### DETAILED DESCRIPTION

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

### Discussion

Embodiments of the present disclosure include helmet liners, helmets, helmets with deflective structures, helmets with thermochromic features, and methods of making helmet liners, helmets with deflective structures, and helmets with thermochromic features. Embodiments of the present disclosure are advantageous over previous solutions for the reasons described herein.

In new generation helmets, softer materials are being used in the body of the outer shell due to requirements of enhanced ballistic performance. A softer shell, however, adversely influences the ear to ear crush resistance of the helmet. In an embodiment of the present disclosure, carbon fiber reinforced polyarylamide and carbon fiber reinforced poly phenylene sulfide long fiber thermoplastics (LFTs) have been used to design and fabricate a rim stiffened liner for an outer shell of a helmet (e.g., a military helmet).

Long fiber thermoplastics are advantageous because, unlike continuous fiber reinforced composites, they can be processed using traditional plastics molding equipment, and, therefore, parts can be manufactured at medium to high volume rates with excellent consistency and repeatability. Long fibers (e.g., fiber lengths of about 3 mm to 50 mm) provide elastic modulus and tensile strength of about 80% to 90% of that obtained using continuous fibers. The use of a thermoplastic matrix gives the molder the ability to modify and enhance the properties of the resin by blending additives, fillers, and fire retardants, depending on the nature of the application.

LFT components can be manufactured using conventional extrusion-compression molding and/or injection molding techniques. The extrusion-compression molding approach provides intimate fiber to resin interaction, thus, a much improved fiber/matrix interface, which is required to obtain superior mechanical properties. In the case of LFT-extrusion-compression molding, the process begins by hot melt impregnating reinforcing fibers with a thermoplastic matrix, and subsequently cutting (e.g., chopping) the continuous tow into pellets (or other structure) of a set length (e.g., about 3 mm to 50 mm). The long fiber pellets are fed into a structure (e.g., a hopper of a single screw low shear extruder). A molten charge of a predetermined size and shape is extruded, which is then transferred by an operator (or a robot) to the compression molding press (or other press) for the forming operation.

In an embodiment of hot melt impregnation, a fiber tow(s) is passed through a series of heated pins that spreads the tow prior to entry into a closed die. An extruder feeds polymer to the die and the fiber filaments are uniformly wetted out with the polymer. The material exiting the extruder is chilled and rolled on take-up rolls. The die design shapes the material into rods, tapes, or profiled sections.

As mentioned above, embodiments of the present disclosure include long fiber thermoplastic structures such as helmet liners and helmets. Embodiments of the present disclosure include long fiber thermoplastic structures that include a thermoplastic resin and a continuous reinforcing fiber (eventually cut into discontinuous reinforcing fibers. The continuous reinforcing fiber is hot melt impregnated with the thermoplastic resin. Subsequently, the mixture can be cooled and formed (e.g., chopped) into a discontinuous reinforcing fiber pellet. In an embodiment, the amount of thermoplastic resin can be about 0.1 to 99 weight % or about 50 to 99 weight %, of the LFT material and the amount of continuous reinforcing fiber (and once cut into the discontinuous reinforcing fiber) can be about 0.1 to 99 weight % or about 0.1 to 50 weight %, of the LFT material. The relative amount of each of thermoplastic resin and the continuous reinforcing fiber can be adjusted to fit the needs of the desired structure and its properties.

In an embodiment, the thermoplastic resin can include a polyaryl amide, a polyphenylene sulfide, a polypropylene, a poly ether ether ketone, a poly ether ketone, a polyethylene, a poly butylene terepthalate, a poly ethylene terepthalate, a polyoxymethylene, or a combination thereof.

In an embodiment, the continuous reinforcing fiber (or the discontinuous reinforcing fiber once cut) can include carbon, glass, aramid, polypropylene, polyethylene, basalt, poly{diimidazo pyridinylene (dihydroxy) phenylene}, or a combination thereof.

Embodiments of the present disclosure include a method for making a long fiber thermoplastic structure such as a helmet liner or a helmet. The method includes hot melt impregnating a continuous reinforcing fiber with a thermoplastic matrix to form a continuous tow. The continuous tow is formed (e.g., cut) into a plurality of pellets. The pellets include a discontinuous reinforcing fiber formed from the cutting of the continuous reinforcing fiber. Subsequently, the plurality of pellets is introduced into a structure to form long fiber thermoplastic, which is then extruded to form a plurality of molten charges. A continuous reinforcing fiber is introduced to a compression molding press and the molten charge is transferred to the compression molding press. The molten charge is formed into a structure, where the structure includes the continuous reinforcing fiber and the long fiber thermoplastic. The amount of material used can depend on, at least in part, the size of the structure (e.g., helmet liner) formed, the use of the structure, the desired properties of the structure, the materials used to form the structure, and the like.

In an embodiment, two materials that are used in the helmet liner are listed in Table 1, and their properties provided. With the helmet liner attached on the ballistic helmet shell, an about 66% increase of ear-to-ear crush rigidity was obtained with only about 20% weight penalty added. The helmet liner materials have a density of about 1.4 g/cm³, which results in a weight (after machining) of about 250 to 300 grams.

TABLE 1
LFT material properties

| LFT | | Tensile | Tensile | | Flexural | Flexural |
|---|---|---|---|---|---|---|
| Mate- | Descrip- | Modulus | Strength | Density | Modulus | Strength |
| rials | tion | (GPa) | (MPa) | (g/cm3) | (GPa) | (MPa) |
| 40% | 0.5″ | 18-30 | 51-65 | 1.49 | 14-20 | 190-250 |
| C-PPS | pellets | | | | | |
| 40% | 1″ | 32-45 | 84-100 | 1.38 | 12-25 | 200-260 |
| C-PAA | pellets | | | | | |

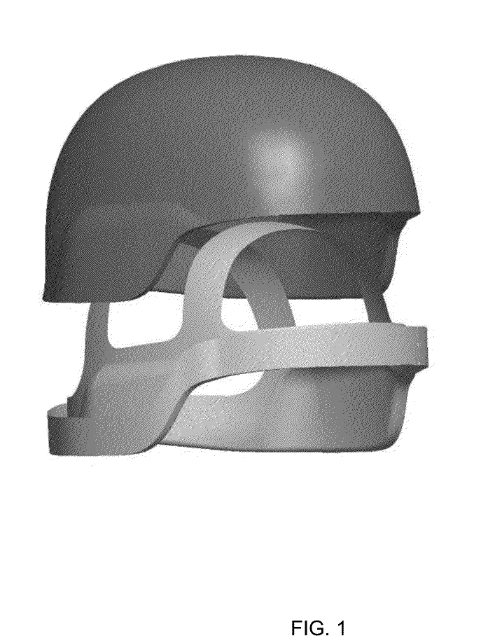

Embodiments of the present disclosure effectively utilize the advantages of lower cost and high volume processability of LFTs. In an embodiment, a LFT rim stiffened helmet liner provides reduced ear to ear deflection, without a significant weight penalty. Cost and weight savings, and increased ballistic protection, can be achieved by the embodiments of the present disclosure. An embodiment of the rim stiffened liner and its fitment to the outer shell of a helmet is illustrated in FIG. 1.

The geometry of the helmet liners is complex and is optimized to provide reduced ear to ear deflection, without a significant weight penalty. The liner is rim-stiffened (e.g., provides support at the rim) at the base of the helmet, and it contours and conforms to the inner geometry of the helmet shell. The liner has various cut-out patterns, which help to minimize weight. The cut-outs can be shape-optimized to provide enhanced torsional and bending rigidity. In an embodiment shown in FIG. 1, the helmet liner includes one or more straps over the head between the helmet and the head, one or more straps across the forehead and/or back of the head, a portion along the side of the head (in the area near the ear and or upper portion of the neck). In an embodiment the width and thickness of the helmet liner can vary from 1 mm to 10s of mm or 100s of mm. The width and thickness of the helmet liner can vary across the helmet liner depending upon the use or purpose of each portion of the helmet liner. For example, the portion of the helmet liner near the ear or upper neck may be thicker than the straps over the top of the head since each portion has a different purpose. The particular dimensions for each portion of the helmet liner can depend, at least in part, the size of the helmet, the use of the helmet, the desired properties of the helmet liner with or without the helmet, the materials used to form the helmet liner, and the like.

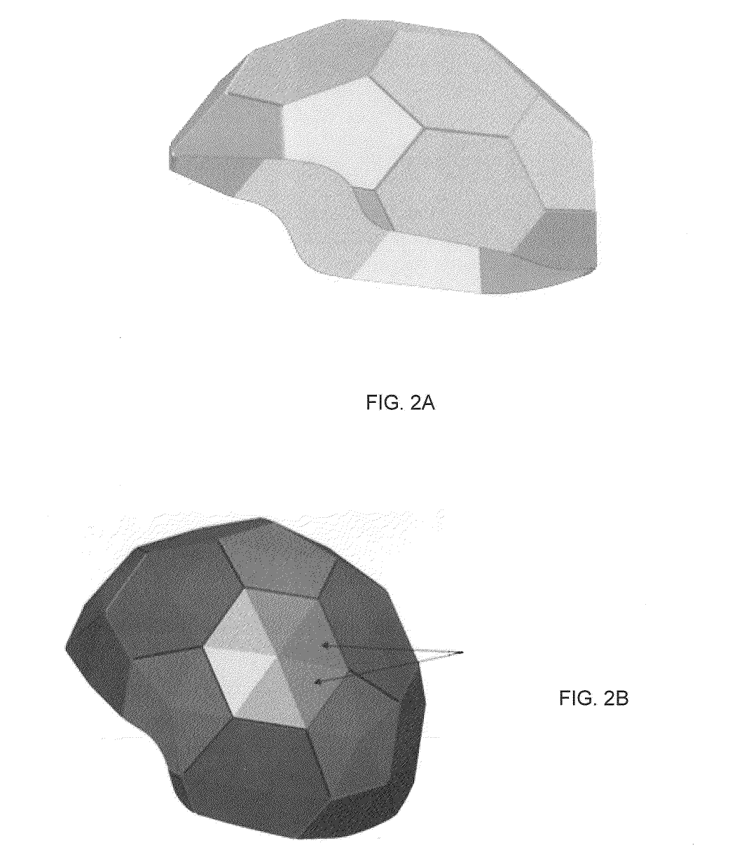

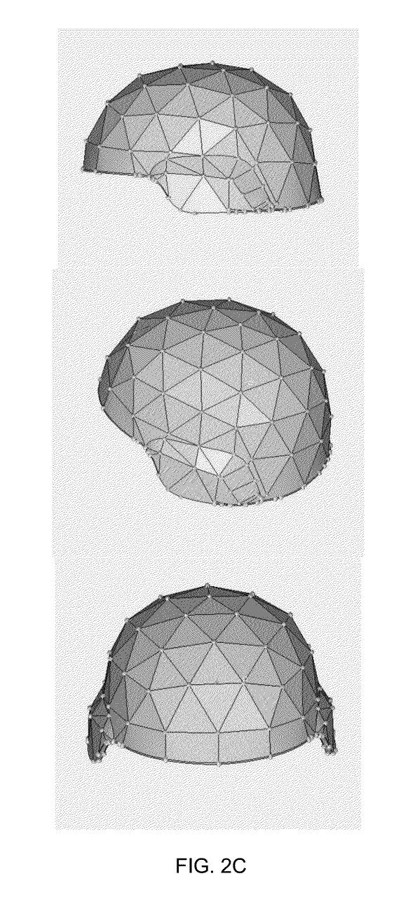

In an embodiment of the present disclosure, the structure is a helmet liner configured to fit inside a helmet with a contour of an outer shell having a smooth surface, a flat face deflective surface, a prism deflective surface, or a combination thereof. As used in this disclosure an embodiment of a smooth helmet structure is considered a traditional helmet and is illustrated in FIG. 1; an embodiment of a flat face deflective helmet structure is illustrated in FIG. 2A; and an embodiment of a prism deflective helmet structure is illustrated in FIG. 2B.

Embodiments of the present disclosure include deflective helmets with high levels of geometric complexity. Embodiments of the present disclosure include helmets where the outer shell of the helmet is contoured.

Embodiments of the present disclosure include helmets where the outer shell of the helmet is contoured with a plurality of flat face deflective surfaces. The surfaces can have polygonal shapes such as triangle, hexagon, pentagons, etc, and a combination thereof. The dimensions of the shapes can range from millimeters to 10s of millimeters to 100s of millimeters to 1000s of millimeters, depending upon the design and purpose of the flat face deflective surface.

Embodiments of the present disclosure include helmets where the outer shell of the helmet is contoured with a plurality of prism deflective surfaces. In an embodiment, the prism deflective surfaces includes a unit having a plurality of triangles (subunits) merging to an elevated center point so that deflection can be achieved with each subunit. Thus, a difference between the flat face deflective surfaces and the prism deflective surfaces is that the center point of the prism deflective surfaces is elevated and the entire surface of the flat face deflective surface is flat. The units can have polygonal shapes such as triangle, hexagon, pentagons, etc, and a combination thereof. The dimensions of the units can range from millimeters to lOs of millimeters to 100s of that can include 2 or more subunits millimeters to 1000s of millimeters, depending upon the design and purpose of the prism deflective surface. The elevation of the center point can be about 1 mm to lOs of mm.

The contour of the outer shell of a present generation helmet is smooth (e.g., rounded). By featuring deflective shapes on the outer shell of the helmet, the blast and ballistic resistance of the shell can be enhanced. A blast wave can deflect off the deflective surface. In addition, a bullet can have minimal chance of normal incidence and has the potential to deflect off the surface.

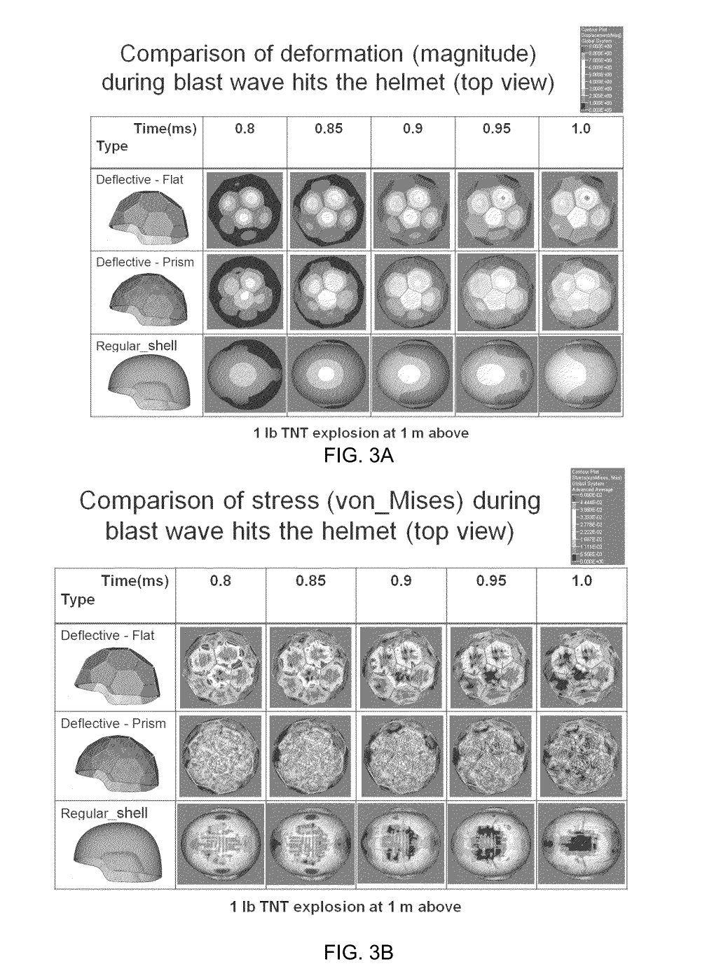

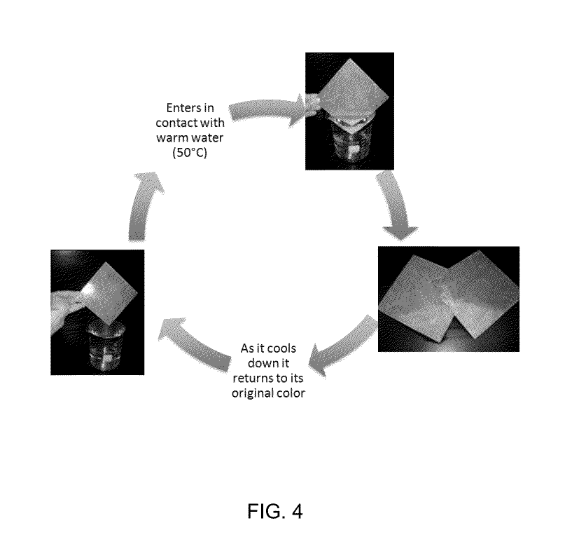

FIGS. 2A-2B illustrate the deflective shell in two embodiments—a flat face features (FIG. 2A) and prism features (FIG. 2B). FIG. 3 illustrates modeling and simulation results that illustrate the effectiveness of a deflective shell. A finite element analysis was performed to computationally evaluate blast resistance of the three different types of helmet. The blast function used in the simulation incorporates Friedlander's equation to calculate the pressure load for a given equivalent mass of Tri-Nitro-Toluene (TNT) at a given distance. FIG. 3 shows the comparison of deformation (magnitude) and stress (von Mises) during blast wave hits the top of the helmets. From the result, it was noted that the deflective prism shell would disperse effectively the blast induced stress wave.

The deflective surface helmet shell can be produced by continuous fiber composites and long fiber thermoplastic processing techniques. The long fiber thermoplastic processing approach would be similar to that described earlier. The continuous fiber composite shell can be compression molded from pre-pregs made from thermoplastic or thermoset systems. These include fiber reinforcements such as glass, aramid, carbon, polypropylene, polyethylene, basalt, poly{diimidazo pyridinylene (dihydroxy) phenylene}, and a combination thereof. The thermoplastic resin systems are polyaryl amide, polyphenylene sulfide, polypropylene, poly ether ether ketone, poly ether ketone, polyethylene, poly butylene terepthalate, poly ethylene terepthalate, polyoxymethylene, a combination thereof, and blends of these polymers in thermoplastic. The thermoset resin systems include epoxy, vinyl ester, phenolic, bismaleimide, and a combination thereof.

Embodiments of the present disclosure can include helmets that can include continuous fiber materials such as: glass, aramid, carbon, polypropylene, polyethylene, basalt poly{diimidazo pyridinylene (dihydroxy) phenylene}, or a combination thereof. In an embodiment the helmets include a polymer such as: a thermoplastic (e.g., a polyaryl amide, a polyphenylene sulfide, a polypropylene, a poly ether ether ketone, a poly ether ketone, a polyethylene, a poly butylene terepthalate, a poly ethylene terepthalate, a polyoxymethylene, and a combination thereof) a thermoset (e.g., epoxy, vinyl ester, phenolic, bismaleimide), or a combination thereof.

Embodiments of the present disclosure can include a helmet, comprising: an outer shell (or cap), where the outer shell (or cap) is contoured with a plurality of flat face deflective surfaces as depicted in FIG. 2A. In an embodiment, the helmet is molded using long fiber or continuous thermoplastic molding processes.

Embodiments of the present disclosure can include a helmet, where the helmet comprises a cap that can retro fit an outer shell of a helmet such as those currently used.

Embodiments of the present disclosure can include a helmet that includes an outer shell, where the outer shell is contoured with a plurality of prism deflective surfaces. In an embodiment, the helmet is molded using thermoplastic molding processes. The helmet can be molded with a long fiber thermoplastic extrusion-compression molding or an extrusion-compression exterior deflective shell with the inside thickness built up by a material such as glass mat or carbon mat thermoplastic. The outer shell can be thin and bonded to a conventional smooth shell helmet such as the ACH. The conventional shell continues to perform the ballistic and protection function, while the deflective outer shell (or cap) performs the function of deflecting blast waves and providing non-normal angles of incidence for bullets/projectiles.

Embodiments of the present disclosure can also include helmets with thermochromic features. The thermochromic pigments, based upon the composition, can change from about -10° C. to 40° C.

Fiber reinforcement is usually sized for thermoset resins such as epoxy, vinyl esters, and polyesters. The deflective helmet plus helmet liner is further functionally enhanced by a pigment based sensor innovation. This involves integrating colors in the thermoplastic resins that serve as sensors transitioning from colored to colorless at specific temperatures.

At lower temperatures, the thermochromic color is either blue, green, turquoise, or the like. When the temperature is increased, the thermochromic pigments start fading to become colorless. Regular pigments can also be mixed with thermochromic pigment so that the color can be changed from one to another.

The thermochromic technology may be used in conjunction with extrusion-compression molding LFT helmet shells and inserts, and incorporating color changing designs with the polymer systems. Its application as a sensor involves environments where temperature rise is of concern, and no special instrumentation would be required to detect thermal changes. Thus, the material that a helmet is made of is inherently an indicator (sensor) of the thermal field.

Embodiments of the present disclosure include process windows for LFT and continuous fiber composites integrated with thermochromic pigments. LFT composites already offer benefits of tailored stiffness, strength, and impact resistance to a part/component. Thermochromic pigments offer functional characteristics to a LFT composite in that they change from colored to colorless at specific transition temperature(s).

A functionally enhanced LFT structure can serve both as a structural reinforcement and as a thermal sensor. For example, a TH-40 pigment changes from colored state (such as from green, blue, etc.) to colorless at about 40° C. LFT composites effectively exhibit thermal transitions with very small thermochromic pigment loading (<2% volume).

Embodiments of the present disclosure can include a helmet where the helmet is functionally enhanced with thermochromic pigments. The helmet can include a traditional smooth shell helmet or deflective helmets with high levels of geometric complexity. The high levels of geometric complexity can include those illustrated in FIGS. 2A-2B.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include ±1%, ±2%, ±3%, ±4%, ±5%, ±6%, ±7%, ±8%, ±9%, or ±10%, or more of the numerical value(s) being modified. In an embodiment, the term “about” can include traditional rounding according to significant figures of the numerical value. In addition, the phrase “about ‘x’ to ‘y’” includes “about ‘x’ to about

It should be emphasized that the above-described embodiments of the present disclosure are merely possible examples of implementations, and are merely set forth for a clear understanding of the principles of the disclosure. Many variations and modifications may be made to the above-described embodiments. All such modifications and variations are intended to be included herein within the scope of this disclosure and protected by the following claims.

Therefore, at least the following is claimed:

1. A long fiber thermoplastic structure, comprising:
a thermoplastic resin; and
a plurality of discontinuous reinforcing fiber, wherein each of the discontinuous reinforcing fiber has a fiber length of about 3 mm to 50 mm.

2. The long fiber thermoplastic structure of any one of claims 1 or 3 to 5, wherein the thermoplastic resin is chosen from: a polyaryl amide, a polyphenylene sulfide, a polypropylene, a poly ether ether ketone, a poly ether ketone, a polyethylene, a poly butylene terepthalate, a poly ethylene terepthalate, a polyoxymethylene, and a combination thereof.

3. The long fiber thermoplastic structure of any one of claim 1, 2, 4, or 5, wherein the discontinuous reinforcing fiber is chosen from: carbon, glass, aramid, polypropylene, polyethyelene, basalt, poly{diimidazo pyridinylene (dihydroxy) phenylene}, and a combination thereof.

4. The long fiber thermoplastic structure of any one of claims 1 to 3, wherein the structure comprises a helmet liner.

5. The long fiber thermoplastic structure of claim 4, wherein the structure is configured to fit inside a helmet with a contour of an outer shell chosen from: smooth, flat face deflective, and prism deflective.

6. A long fiber thermoplastic structure, comprising:
a thermoplastic resin; and
a continuous reinforcing fiber, wherein the continuous reinforcing fiber is hot melt impregnated with the thermoplastic resin.

7. The long fiber thermoplastic structure of any one of claims 6 or 8 to 10, wherein the thermoplastic resin is chosen from: a polyaryl amide, a polyphenylene sulfide, a polypropylene, a poly ether ether ketone, a poly ether ketone, a polyethylene, a poly butylene terepthalate, a poly ethylene terepthalate, a polyoxymethylene, and a combination thereof.

8. The long fiber thermoplastic structure of any one of claim 6, 7, 9, or 10, wherein the continuous reinforcing fiber is chosen from: carbon, glass, aramid, polypropylene, polyethyelene, basalt, poly{diimidazo pyridinylene (dihydroxy) phenylene}, and a combination thereof.

9. The long fiber thermoplastic structure of any one of claim 6 to 8 or 10, wherein the structure comprises a helmet liner.

10. The long fiber thermoplastic structure of any one of claims 6 to 9, wherein the structure is configured to fit inside a helmet with a contour of an outer shell chosen from: smooth, flat face deflective, and prism deflective.

11. A method for making a long fiber thermoplastic structure, comprising:
hot melt impregnating a continuous reinforcing fiber with a thermoplastic matrix to form a continuous tow;
cutting the continuous tow into a plurality of pellets, wherein the pellets include a discontinuous reinforcing fiber formed from the cutting of the continuous reinforcing fiber;
feeding the plurality of pellets into a structure to form long fiber thermoplastic;
extruding a plurality of molten charges;
introducing a continuous reinforcing fiber to a compression molding press;
transferring the molten charge to the compression molding press; and
forming the molten charge into a structure, wherein the structure includes the continuous reinforcing fiber and the long fiber thermoplastic.

12. The method of any one of claim 11, 13, or 14, wherein the thermoplastic resin is chosen from: a polyaryl amide, a polyphenylene sulfide, a polypropylene, a poly ether ether ketone, a poly ether ketone, a polyethylene, a poly butylene terepthalate, a poly ethylene terepthalate, a polyoxymethylene, and a combination thereof.

13. The method of any one of claim 11, 12, or 14, wherein the discontinuous reinforcing fiber is chosen from: carbon, glass, aramid, polypropylene, polyethyelene, basalt, poly{diimidazo pyridinylene (dihydroxy) phenylene}, and a combination thereof.

14. The method of any one of claims 11 to 13, wherein the structure comprises a helmet liner.

15. A helmet comprising:
a continuous fiber material; and
a polymer, wherein the polymer is chosen from: a thermoplastic polymer and a thermoset polymer.

16. The helmet of any one of claims 15 or 17 to 24, wherein the continuous fiber material is chosen from: glass, aramid, carbon, polypropylene, polyethylene, basalt, poly{diimidazo pyridinylene (dihydroxy) phenylene}, and a combination thereof.

17. The helmet of any one of claims 15, 16, or 18 to 24, wherein the polymer is a thermoplastic chosen from: a polyaryl amide, a polyphenylene sulfide, a polypropylene, a poly ether ether ketone, a poly ether ketone, a polyethylene, a poly butylene terepthalate, a polyoxymethylene, and a combination thereof.

18. The helmet of any one of claims 15 to 17 or 19 to 24, wherein the polymer is a thermoset chosen from: an epoxy, a vinyl ester, a phenolic, a bismaleimide, and a combination thereof.

19. The helmet of any one of claims 15 to 18, comprising:
an outer shell, wherein the outer shell is contoured with a plurality of flat face deflective surfaces.

20. The helmet of claim 19, wherein the helmet comprises a cap that retro fits an outer shell of a helmet.

21. The helmet of any one of claims 15 to 18, comprising:
an outer shell, where the outer shell is contoured with a plurality of prism deflective surfaces.

22. The helmet of claim 21, wherein the helmet comprises a cap that retro fits an outer shell of a helmet.

23. The helmet of claim 19, where the helmet includes thermochromic pigments.

24. The helmet of claim 21, where the helmet includes thermochromic pigments.
